(19) United States
(12) Patent Application Publication
(10) Pub. No.: US 2025/0300494 A1
(43) Pub. Date: Sep. 25, 2025

(54) POWER SUPPLY DEVICE AND POWER TRANSMISSION SYSTEM

(71) Applicant: CASIO COMPUTER CO., LTD., Tokyo (JP)

(72) Inventor: Tomio HIGO, Tokyo (JP)

(73) Assignee: CASIO COMPUTER CO., LTD., Tokyo (JP)

(21) Appl. No.: 19/088,253

(22) Filed: Mar. 24, 2025

(30) Foreign Application Priority Data
Mar. 25, 2024 (JP) 2024-047572

(51) Int. Cl. H02J 50/10; A63H 13/00; H02J 50/90

(52) U.S. Cl. CPC H02J 50/10; A63H 13/005; H02J 50/90; A63H 2200/00

(57) ABSTRACT

An power supply device includes a housing to accommodate an electronic device to supply power in a non-contact manner to the electronic device. The housing includes a floor on which the electronic device is placed and a side wall to surround the electronic device. The side wall is provided with a plurality of wall-side protrusions protruding inward from the side wall.

### CROSS-REFERENCE TO RELATED APPLICATIONS

This application claims the priority of Japanese Patent Application No. 2024-047572, filed on Mar. 25, 2024, the entire disclosure of which is incorporated by reference herein.

### FIELD OF THE INVENTION

The present disclosure relates to a power supply device and a power transmission system.

### BACKGROUND OF THE INVENTION

In recent years, electronic devices that receive wireless power supply from power supply devices and charge built-in batteries have been used. For example, Unexamined Japanese Patent Application Publication No. 2010-119251 discloses a technique in which a power transmission unit determines whether a power reception unit is positioned properly.

### SUMMARY OF THE INVENTION

A power supply device according to the present disclosure includes a housing to accommodate an electronic device to supply power to the electronic device in a non-contact manner. The housing includes a floor where the electronic device is placed and a wall surrounding the electronic device. The wall is provided with a plurality of wall-side protrusions protruding inward from the wall.

### BRIEF DESCRIPTION OF DRAWINGS

A more complete understanding of this application can be obtained when the following detailed description is considered in conjunction with the following drawings, in which:

FIG. 1 is a perspective view of an electronic device and a power supply device according to Embodiment 1;

FIG. 2 is a perspective view of a body of the electronic device according to Embodiment 1;

FIG. 3 is a top view of the power supply device according to Embodiment 1;

FIG. 4 is a top view of the electronic device and the power supply device according to Embodiment 1 in an accommodated state;

FIG. 5 is a side view of a wall-side protrusions according to Embodiment 1;

FIG. 6 is a configuration diagram of a power transmission system according to Embodiment 1;

FIG. 7 is a cross-sectional view taken along the A-A line illustrated in FIG. 4;

FIG. 8 is an enlarged view of an area enclosed by a dashed line 50 illustrated in FIG. 7; and

FIG. 9 is a top view of a power supply device according to Embodiment 2.

### DETAILED DESCRIPTION OF THE INVENTION

Embodiments of the present disclosure are described below in detail with reference to drawings. The same reference signs are used to refer to the same or corresponding components throughout the drawings.

### Embodiment 1

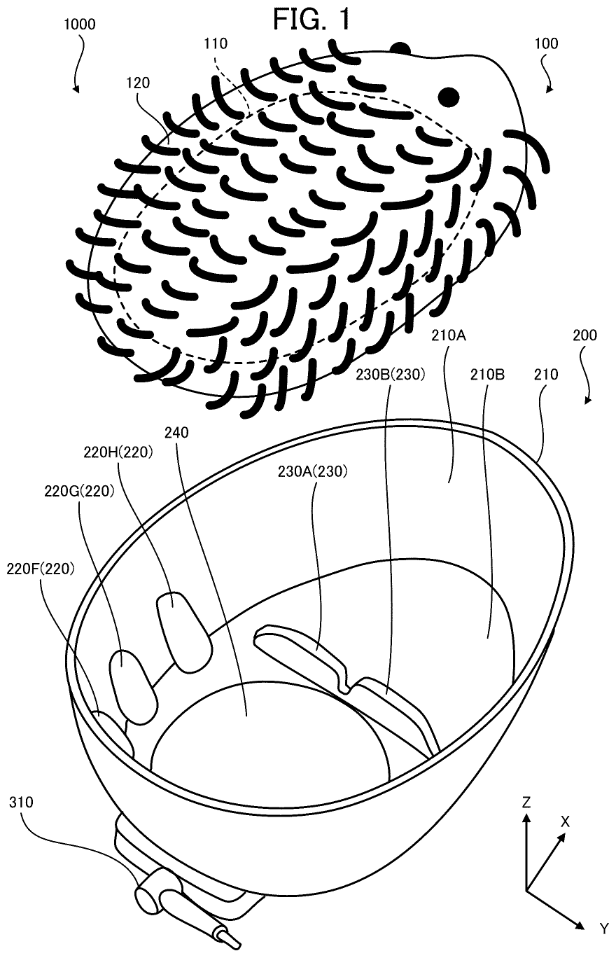

First, the appearance of an electronic device 100 and a power supply device 200 included in a power transmission system 1000 according to this embodiment is described with reference to FIG. 1. The power transmission system 1000 is a system in which the power supply device 200 wirelessly supplies power to the electronic device 100. The power supply device 200 wirelessly supplies power to the electronic device 100 when the electronic device 100 is accommodated in a housing 210 of the power supply device 200. Wireless means non-contact, which implies that there are no cable connections, electrode contacts, or the like.

The electronic device 100 is a device that operates on the power stored in a built-in battery in the electronic device 100. The electronic device 100 charges the built-in battery with the power supplied by the power supply device 200. In this embodiment, the electronic device 100 is a robot that operates autonomously without direct user operation. More specifically, the electronic device 100 is a pet robot that imitates a small animal. The electronic device 100 includes a body 110 and an exterior 120.

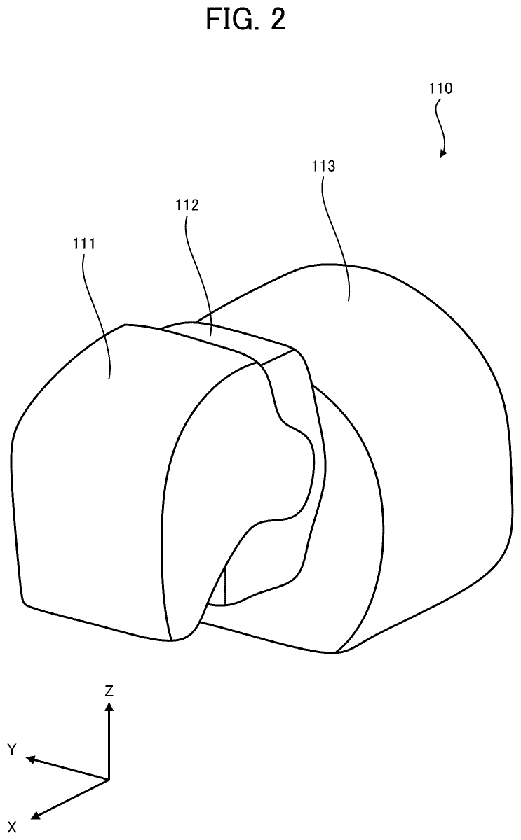

The body 110 contains various components necessary for operation of the electronic device 100. As illustrated in FIG. 2, the body 110 includes a head 111, a joint 112, and a torso 113. The head 111 corresponds to the head of a small animal. The joint 112 connects the head 111 to the torso 113 rotatably. The torso 113 corresponds to the body of a small animal.

The exterior 120 covers the body 110. The exterior 120 includes eye-like decorative components, and fluffy fur. The surface material of the exterior 120 is, for example, made of an artificial pile fabric that imitates a small animal's fur, to simulate the feel of a small animal. The lining of the exterior 120 is made of, for example, fibers, leather, rubber, or the like. Since the exterior 120 is made of a flexible material, the exterior 120 can follow movement of the body 110.

The power supply device 200 is a device that supplies power wirelessly to the electronic device 100. The power supply device 200 functions as a charging station to charge the battery included in the electronic device 100. The power supply device 200 receives power from an alternating current (AC) adapter equipped with a direct current (DC) plug 310. The power supply device 200 includes the housing 210 for accommodating the electronic device 100. The housing 210 has a bowl-like shape that imitates a small animal's house. More specifically, the housing 210 has a shape that resembles an egg split in half along a plane that includes the central axis extending in the longitudinal direction.

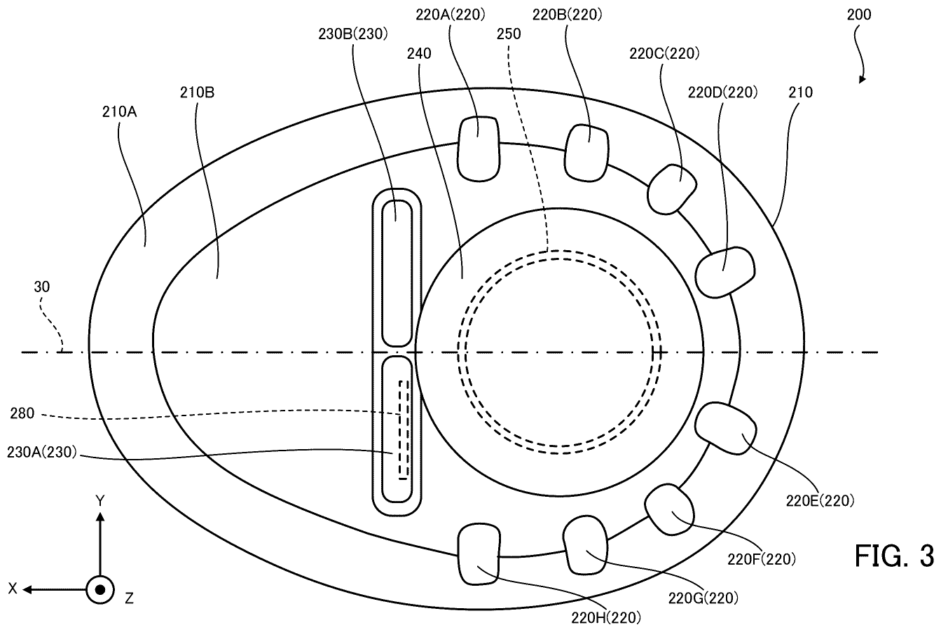

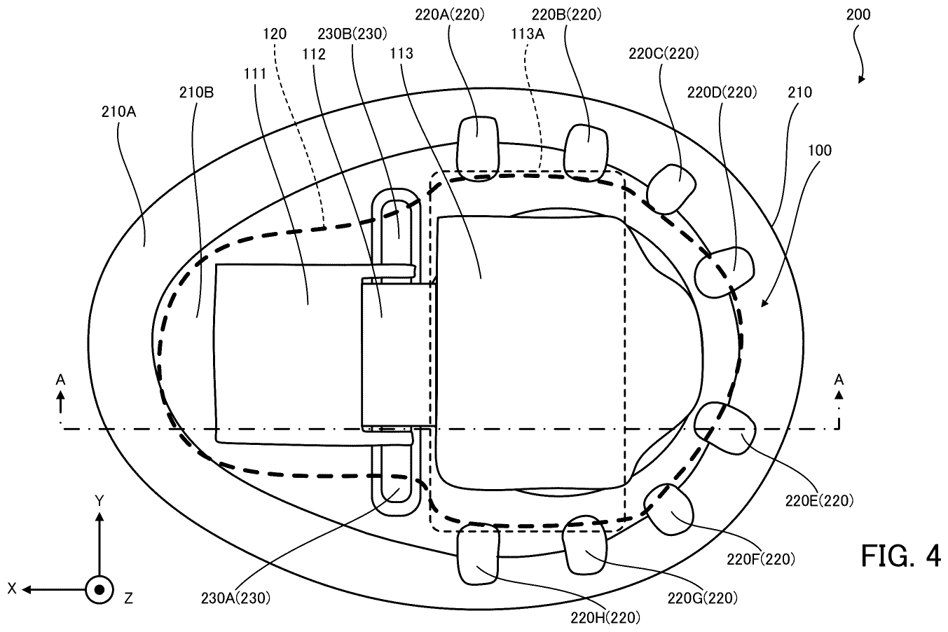

FIG. 3 illustrates a top view of the power supply device 200. FIG. 4 illustrates a top view of the electronic device 100 and the power supply device 200 in an accommodated state. The accommodated state is a state in which the electronic device 100 is accommodated in the housing 210 included in the power supply device 200, making it possible to supply power to the electronic device 100. In this embodiment, the axis extending in the vertical direction is the Z-axis, the axis extending in the direction orthogonal to the Z-axis is the X-axis, and the axis extending in the direction orthogonal to both the Z-axis and the X-axis is the Y-axis. In this embodiment, the power supply device 200 is arranged such that the direction

extending from the rear end to the front end of the housing 210 in the longitudinal direction is the positive direction of the X-axis. The front end in the longitudinal direction of the housing 210 is the more pointed end among both ends in the longitudinal direction of the housing 210. In addition, in this embodiment, the electronic device 100 is arranged such that the direction extending from the torso 113 to the head 111 is the positive direction of the X-axis. In other words, in this embodiment, the head 111 of the body 110 of the electronic device 100 is arranged at the front end in the longitudinal direction of the housing 210 of the power supply device 200, and the electronic device 100 is accommodated in the housing 210 of the power supply device 200.

The electronic device 100 may be accommodated in the housing 210 either automatically or manually. For example, the electronic device 100 may automatically move into the housing 210 in response to the remaining battery level falling below a reference value. Alternatively, the user may accommodate the electronic device 100 in the housing 210 in accordance with notification from the electronic device 100. This notification indicates that the remaining battery level is low and is issued by the electronic device 100 in response to the remaining battery level falling below the reference value.

A stand 240 for placing the electronic device 100 is provided at the bottom of the housing 210. The stand 240 has a disc shape. Below the stand 240, a power transmission coil 250 is provided. The power supply device 200 wirelessly supplies power to the electronic device 100 when the electronic device 100 is placed on the stand 240. An alternating current flows through the power transmission coil 250 for power supply. The housing 210 includes a side wall 210A surrounding the electronic device 100 and a floor 210B on which the electronic device 100 is placed. The side wall 210A is an example of the wall. The side wall 210A is provided with a plurality of wall-side protrusions 220 protruding inward from the side wall 210A. In this embodiment, there are eight wall-side protrusions 220, namely wall-side protrusions 220A, 220B, 220C, 220D, 220E, 220F, 220G, and 220H. Additionally, the floor 210B is provided with a plurality of floor-side protrusions 230 protruding upward from the floor 210B. In this embodiment, there are two floor-side protrusions 230, namely a floor-side protrusion 230A and a floor-side protrusion 230B. The wall-side protrusions 220 and floor-side protrusions 230 restrict movement of the electronic device 100 accommodated in the housing 210. That is, the wall-side protrusions 220 and floor-side protrusions 230 suppress a positional shift of the electronic device 100 in the housing 210. The positional shift of the electronic device 100 corresponds to the positional shift between the central axis of the power transmission coil 250 and the central axis of the power reception coil 150. In other words, the wall-side protrusions 220 and floor-side protrusions 230 restrict the movement of the electronic device 100 accommodated in the housing 210 so that the positional shift between the central axis of the power transmission coil 250 and the central axis of the power reception coil 150 remains within an allowable range.

In this embodiment, the floor-side protrusions 230A and 230B have a shape extending in a second direction substantially orthogonal to the first direction and are arranged in a straight line extending in the second direction. Substantially orthogonal means roughly orthogonal, not necessarily strictly orthogonal. The first direction is a direction in which the X-axis extends, and the second direction is a direction in which the Y-axis extends. The floor-side protrusions 230A and 230B restrict the movement of the electronic device 100 in a direction corresponding to a first orientation in the first direction.

The direction corresponding to the first orientation in the first direction is a positive direction of the X-axis, and the direction corresponding to a second orientation in the first direction is the negative direction of the X-axis. The floor-side protrusions 230A and 230B basically restrict movement of the portion corresponding to the torso 113 of the electronic device 100 in a direction corresponding to the first orientation in the first direction.

The wall-side protrusions 220 restrict the movement of the electronic device 100 in the first or second direction. Specifically, the wall-side protrusions 220A, 220B, and 220C restrict the movement of the electronic device 100 in the direction corresponding to the first orientation in the second direction. The wall-side protrusions 220F, 220G, and 220H restrict the movement of the electronic device 100 in the direction corresponding to the second orientation in the second direction. The direction corresponding to the first orientation in the second direction is the positive direction of the Y-axis, and the direction corresponding to the second orientation in the second direction is the negative direction of the Y-axis.

The wall-side protrusions 220C, 220D, 220E, and 220F restrict the movement of the electronic device 100 in a direction corresponding to the second orientation in the first direction. Thus, the wall-side protrusions 220 include a wall-side protrusion 220 that restricts the movement of the electronic device 100 in the second direction orthogonal to the first direction. Therefore, the movement of the electronic device 100 in the first and second directions is suppressed by the wall-side protrusions 220 and the floor-side protrusions 230.

The wall-side protrusions 220 and the floor-side protrusions 230 are preferably arranged to allow for some movement of the electronic device 100 so that the movement is not excessively restricted. In this configuration, for example, the breathing motion simulated by the electronic device 100 imitating a small animal within the housing 210 imitating a small animal's house is not restricted. The protrusion amount of the wall-side protrusions 220 from the side wall 210A is determined based on an allowable amount of positional shift of the electronic device 100 in the housing 210. Generally, the smaller the allowable displacement amount, the larger the protrusion amount, and the larger the allowable displacement amount, the smaller the protrusion amount.

Here, a magnet 280 is installed inside the floor-side protrusion 230A. The magnet 280 is used for the electronic device 100 to determine that the power supply device 200 is a suitable power supply device corresponding to the electronic device 100. Thus, the floor-side protrusion 230A has a function of restricting the movement of the electronic device 100 and a function of fixing the magnet 280.

In this embodiment, when the housing 210 is viewed from above, the wall-side protrusions 220 are arranged in mirror symmetry with respect an axis 30 extending in the first direction as a symmetry axis. Specifically, the wall-side protrusions 220A, 220B, 220C, and 220D are arranged in mirror symmetry with wall-side protrusions 220H, 220G, 220F, and 220E, respectively. Two wall-side protrusions 220 arranged in mirror symmetry are hereinafter referred to as a pair of wall-side protrusions 220. The X-coordinates of the pair of wall-side protrusions 220 are the same.

The electronic device 100 has a wide portion 113A that has a length in the width direction of the electronic device 100 longer than other portions. The width direction of the electronic device 100 is the Y-axis direction. The wide portion 113A is a part of the torso 113. The housing 210 accommodates the electronic device 100 such that the width direction of the electronic device 100 is orthogonal to the first direction.

Here, the wall-side protrusions 220 include a first protrusion, a second protrusion adjacent to the first protrusion, a third protrusion arranged in line symmetry with the first protrusion with respect to the axis 30 extending in the first direction as the symmetry axis, and a fourth protrusion adjacent to the third protrusion and arranged in line symmetry with the second protrusion with respect to the axis 30 as the symmetry axis. In this embodiment, the wall-side protrusion 220A is the first protrusion, the wall-side protrusion 220B is the second protrusion, the wall-side protrusion 220H is the third protrusion, and the wall-side protrusion 220G is the fourth protrusion.

Here, the first protrusion, the second protrusion, the third protrusion, and the fourth protrusion are arranged such that when the electronic device 100 is accommodated in the housing 210, the positions of the first protrusion, the second protrusion, the third protrusion, and the fourth protrusion in the first direction are arranged to be positioned between the positions of both ends of the wide portion 113A in the first direction.

For example, among the ends of the wide portion 113A in the first direction, the end with the larger X-coordinate is assumed to be one end of the wide portion 113A in the first direction, and the end with the smaller X-coordinate is assumed to be the other end of the wide portion 113A in the first direction. In this case, the X-coordinates of the wall-side protrusions 220A, 220B, 220G, and 220H are smaller than the X-coordinate of one end of the wide portion 113A in the first direction and larger than the X-coordinate of the other end of the wide portion 113A in the first direction.

That is, regarding the arrangement in the X-axis direction, the wall-side protrusions 220A, 220B, 220G, and 220H are arranged between both the ends of the wide portion 113A. In this case, movement of the wide portion 113A in the positive direction of the Y-axis is suppressed by the wall-side protrusions 220A and 220B. Additionally, movement of the wide portion 113A in the negative direction of the Y-axis is suppressed by the wall-side protrusions 220G and 220H. Thus, the movement of the electronic device 100 in the Y-axis direction is efficiently suppressed by the first protrusion, second protrusion, third protrusion, and fourth protrusion.

An interval between the first protrusion and the second protrusion and an interval between the third protrusion and the fourth protrusion are sized in accordance with a thickness of a finger. For example, these intervals are preferably approximately the same as the thickness of a finger. In such a configuration, for example, when a user accommodates the electronic device 100 in the housing 210 while holding the wide portion 113A of the electronic device 100 with fingers, one finger enters between the first protrusion and the second protrusion, and the other finger enters between the third protrusion and the fourth protrusion. In this case, since the user's finger enters the gap between the side wall 210A and the exterior 120, the user can smoothly accommodate the electronic device 100 in the housing 210.

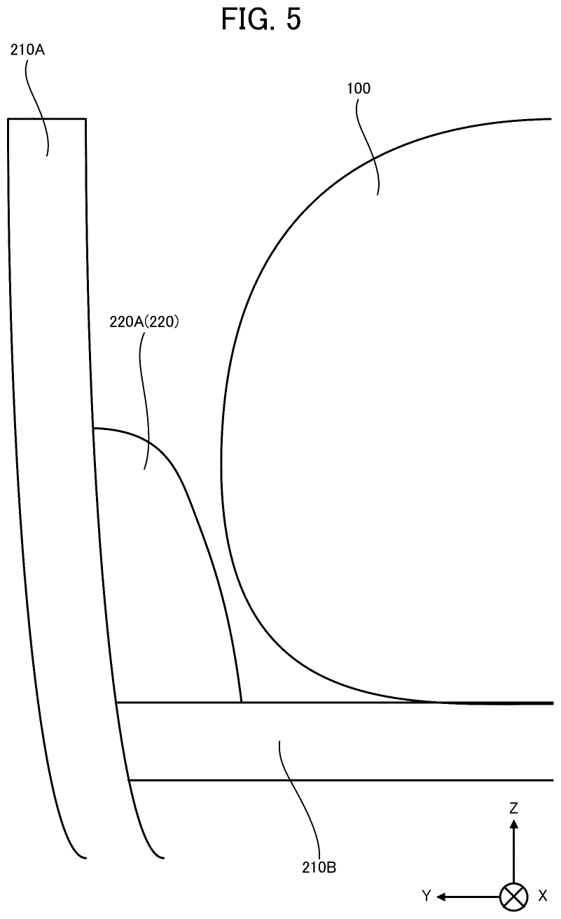

The wall-side protrusions 220 preferably have a rounded shape. In other words, the wall-side protrusions 220 preferably have a shape without corners. FIG. 5 is a side view illustrating the wall-side protrusion 220A when viewed from the positive-direction side of the X-axis. As illustrated in FIG. 5, the wall-side protrusion 220A has a shape extending upward along the side wall 210A from the boundary portion between the side wall 210A and the floor 210B, in a direction away from the floor 210B. Also, the wall-side protrusion 220A has a rounded shape and does not have corners at portions that come into contact with user's fingers, the electronic device 100, etc.

The wall-side protrusions 220 other than the wall-side protrusion 220A have the same shape as the wall-side protrusion 220A. In such a configuration, when the user accommodates the electronic device 100 in the housing 210, the user's fingers, the electronic device 100, etc., are less likely to get caught on the wall-side protrusions 220, allowing for smooth accommodating.

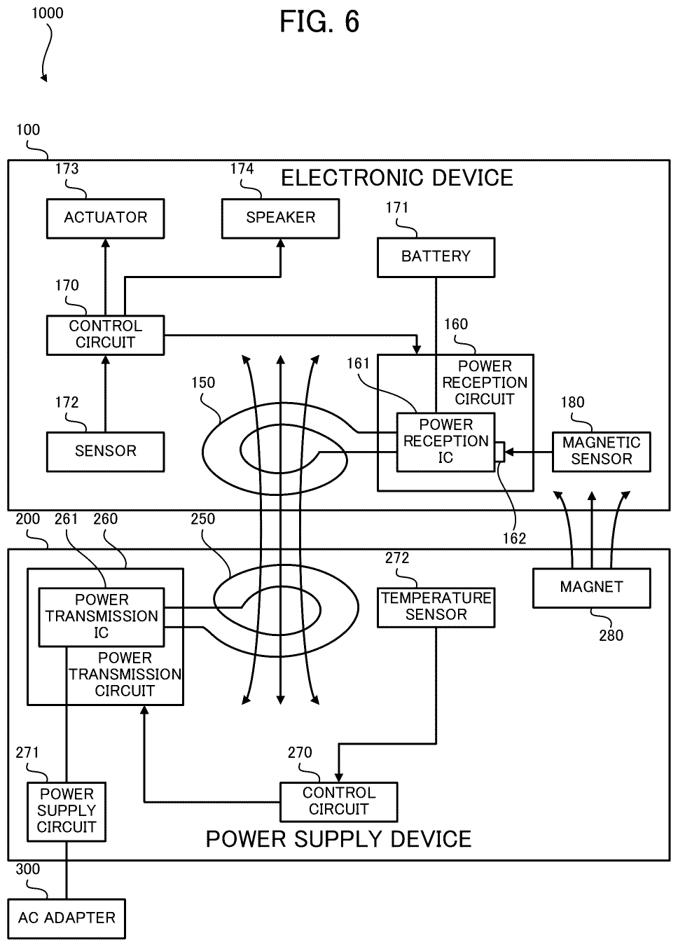

Next, the configuration of the power transmission system 1000 is described with reference to FIG. 6. The power transmission system 1000 includes the electronic device 100 and the power supply device 200. The electronic device 100 includes a power reception coil 150, a power reception circuit 160, a control circuit 170, a battery 171, a sensor 172, an actuator 173, a speaker 174, and a magnetic sensor 180. The power supply device 200 includes a power transmission coil 250, a power transmission circuit 260, a control circuit 270, a power supply circuit 271, a temperature sensor 272, and a magnet 280.

The power reception coil 150 is a coil that couples with the power transmission coil 250 and receives power wirelessly. The power reception coil 150 induces an electromotive force in accordance with changes in the magnetic flux induced by the power transmission coil 250. The power reception coil 150 is a wire wound around an axis extending in the Z-axis direction. The power reception coil 150 is located below the stand 240.

The power reception circuit 160 is a circuit that receives power wirelessly through the power reception coil 150. The power reception circuit 160 supplies, to the battery 171, direct current power based on the alternating current power supplied from the power supply device 200 through the power reception coil 150. The power reception circuit 160 operates in accordance with control by the control circuit 170. The power reception circuit 160 communicates with the power transmission circuit 260. For example, the power reception circuit 160 sends a power supply request to the power transmission circuit 260 to receive power from the power transmission circuit 260. The power reception circuit 160 includes a power reception integrated circuit (IC) 161.

The power reception IC 161 converts alternating current power generated by the electromotive force induced by the power reception coil 150 into direct current power, and supplies the direct current power to the battery 171. The power reception IC 161 includes an operation control terminal 162 for controlling the operation of the power reception IC 161. The power reception IC 161 operates when a first voltage is applied to the operation control terminal 162 and stops operating when a second voltage is applied to the operation control terminal 162. In this embodiment, the first voltage is lower than the second voltage.

When the first voltage is applied to the operation control terminal 162, the power reception IC 161 operates. Therefore, the power reception circuit 160 sends a power supply request to the power transmission circuit 260, and the power supply device 200 performs power supply. When the second voltage is applied to the operation control terminal 162, the power reception IC 161 stops operating. Thus, the power reception circuit 160 does not send a power supply request to the power transmission circuit 260, and power supply by the power supply device 200 is not performed.

In this embodiment, the voltage output by the magnetic sensor 180 is applied to the operation control terminal 162. In other words, in this embodiment, availability of power supply by the power supply device 200 is determined based on a result of magnetism detection made by the magnetic sensor 180. Specifically, when the magnetic sensor 180 detects magnetism, power supply by the power supply device 200 is executed. When the magnetic sensor 180 does not detect magnetism, power supply by the power supply device 200 is not executed. In this case, the operation control terminal 162 is an/EN terminal.

The control circuit 170 controls the overall operation of the electronic device 100. For example, the control circuit 170 operates the electronic device 100 by operating the actuator 173 based on a result of detection made by the sensor 172. Also, when the control circuit 170 receives a notification from the power supply device 200 that a foreign object is detected, the control circuit 170 controls the speaker 174 to notify the user that a foreign object is detected.

The battery 171 is a secondary battery capable of charging and discharging. The battery 171 is a power source of the electronic device 100. In other words, the battery 171 supplies power to the power reception circuit 160, the control circuit 170, the sensor 172, the actuator 173, the magnetic sensor 180, etc. The battery 171 is charged by the power supplied from the power reception circuit 160.

The sensor 172 is a sensor for detecting various physical quantities. Examples of the sensor 172 include a touch sensor, an acceleration sensor, an angular velocity sensor, a sound sensor, an illuminance sensor, and a temperature sensor. The touch sensor, for example, detects that the user touches the exterior 120. The acceleration sensor, for example, detects acceleration applied to the entire or part of the electronic device 100. The angular velocity sensor, for example, detects an angular velocity of the entire or part of the electronic device 100. The sound sensor, for example, detects sound emitted by the user. The illuminance sensor, for example, detects illuminance around the electronic device 100. The temperature sensor, for example, detects internal or external temperature of the electronic device 100. The sensor 172 supplies to the control circuit 170 an electrical signal indicating a result of the detection.

The actuator 173 is a mechanism for operating each part of the electronic device 100. The actuator 173 operates in accordance with the control by the control circuit 170. For example, the actuator 173 is a mechanism for moving the electronic device 100 forward and backward and for rotating the head 111 relative to the torso 113. The actuator 173 includes, for example, a stepping motor.

The speaker 174 emits sound in accordance with the control by control circuit 270. For example, when the power supply device 200 detects a foreign object, the speaker 174 outputs a sound notification indicating that a foreign object is detected, in accordance with an audio signal supplied from control circuit 270.

The magnetic sensor 180 is a sensor that detects magnetism. The magnetic sensor 180 detects magnetism generated by the magnet 280 provided in a predetermined part of power supply device 200. In this embodiment, the magnetic sensor 180 includes a Hall element that detects a magnetic field using the Hall effect and detects the strength of the magnetic field and the orientation of the magnetic pole. However, in this embodiment, the magnetic sensor 180 outputs a voltage corresponding to the strength of the magnetic field regardless of the orientation of the magnetic pole. Specifically, the magnetic sensor 180 outputs a first voltage when the detected strength of the magnetic field is equal to or greater than a reference value. Additionally, magnetic sensor 180 outputs the second voltage when the detected strength of the magnetic field is less than the reference value. In this way, the magnetic sensor 180 outputs the first voltage when detecting magnetism and outputs the second voltage when not detecting magnetism. The detection of magnetism by the magnetic sensor 180 corresponds to the strength of the magnetic field detected by the magnetic sensor 180 being equal to or greater than the reference value. The voltage output by the magnetic sensor 180 is applied to the operation control terminal 162 of the power reception IC 161. Therefore, power supply is allowed when magnetism is detected and not allowed when magnetism is not detected. In this embodiment, the power transmission coil 250 included in the power supply device 200 generates magnetism. Thus, the magnetic sensor 180 is positioned and angled to avoid detecting the magnetism generated by the power transmission coil 250.

The power transmission coil 250 is a coil that couples with the power reception coil 150 and is used to supply power wirelessly. The power transmission coil 250 induces a magnetic flux with a varying magnitude when an alternating current flows through the power transmission coil 250. The power transmission coil 250 is a wire wound around an axis extending in the Z-axis direction. In the accommodated state, the power transmission coil 250 is disposed in a predetermined position within the power supply device 200 such that the power transmission coil 250 faces the power reception coil 150. In the accommodated state, the central axis of the power reception coil 150 and the central axis of the power transmission coil 250 are close to each other.

The power transmission circuit 260 is a circuit for wirelessly supplying power through the power transmission coil 250. The power transmission circuit 260 supplies, to the power transmission coil 250, alternating current power based on the direct current power supplied from the power supply circuit 271. The power transmission circuit 260 operates in accordance with the control by the control circuit 270. The power transmission circuit 260 communicates with the power reception circuit 160. Specifically, when the power transmission circuit 260 receives a power supply request from the power reception circuit 160, the power transmission circuit 260 starts supplying power to the power reception circuit 160. In other words, the power transmission circuit 260 supplies power to the electronic device 100 in response to the power supply request issued when the electronic device 100 detects magnetism generated by the magnet 280. The power transmission circuit 260 includes a power transmission IC 261. The power transmission IC 261 converts the direct current power generated by the power supply circuit 271 into alternating current power and supplies the alternating current power to the power transmission coil 250.

The control circuit 270 controls the overall operation of the power supply device 200. For example, the control circuit 270 controls the power transmission circuit 260 to supply power to the electronic device 100. Also, the control circuit 270 detects a foreign object based on the result of the detection made by the temperature sensor 272. For example, the control circuit 270 determines that there is a foreign object around the power transmission coil 250 when the temperature detected by the temperature sensor 272 is equal to or greater than a reference value or when an increase rate of the temperature detected by the temperature sensor 272 is equal to or greater than a reference value. When the control circuit 270 determines that there is a foreign object, the control circuit 270 notifies the electronic device 100 that a foreign object is detected, prompting the electronic device 100 to notify that there is a foreign object.

The power supply circuit 271 generates various types of power supply voltages used by the power supply device 200. For example, the power supply circuit 271 steps down or steps up the direct current voltage supplied from AC adapter 300 to generate the power supply voltages for the various components of the power supply device 200.

The temperature sensor 272 detects the temperature around the power transmission coil 250. When there is a foreign object including metal around the power transmission coil 250, the change in magnetic flux induced by the power transmission coil 250 causes eddy currents to flow within the foreign object, causing the foreign object to generate heat. The temperature sensor 272 is used to detect the heat generation of the foreign object. The temperature sensor 272 supplies a result of the detection of the temperature to control circuit 270. Temperature sensor 272 includes, for example, a thermistor.

The magnet 280 is an object that generates magnetism. The magnet 280 has two poles, an N pole and an S pole, and is an object that is a source of a bipolar magnetic field. The magnet 280 has a substantially rectangular parallelepiped shape where the length in the longitudinal direction is longer than the length in the width direction, and the length in the width direction is longer than the length in the thickness direction.

The magnet 280 is arranged in a predetermined part in the power supply device 200 to indicate that the power supply device 200 is a suitable power supply device for supplying power to the electronic device 100. In this embodiment, the predetermined part is the floor-side protrusion 230A. The magnet 280 is arranged at a position and an angle corresponding to the position and angle of the magnetic sensor 180. In other words, in the accommodated state, the magnet 280 is positioned and angled to enable detection by the magnetic sensor 180 of the magnetism generated by the magnet 280. In this embodiment, the magnet 280 is a permanent magnet.

The AC adapter 300 is a device for converting alternating current power into direct current power. In this embodiment, the AC adapter 300 converts the alternating current power supplied from the commercial power supply into direct current power, and supplies the direct current power to the power supply circuit 271. The AC adapter 300 includes a DC plug 310 to be connected to the power supply circuit 271.

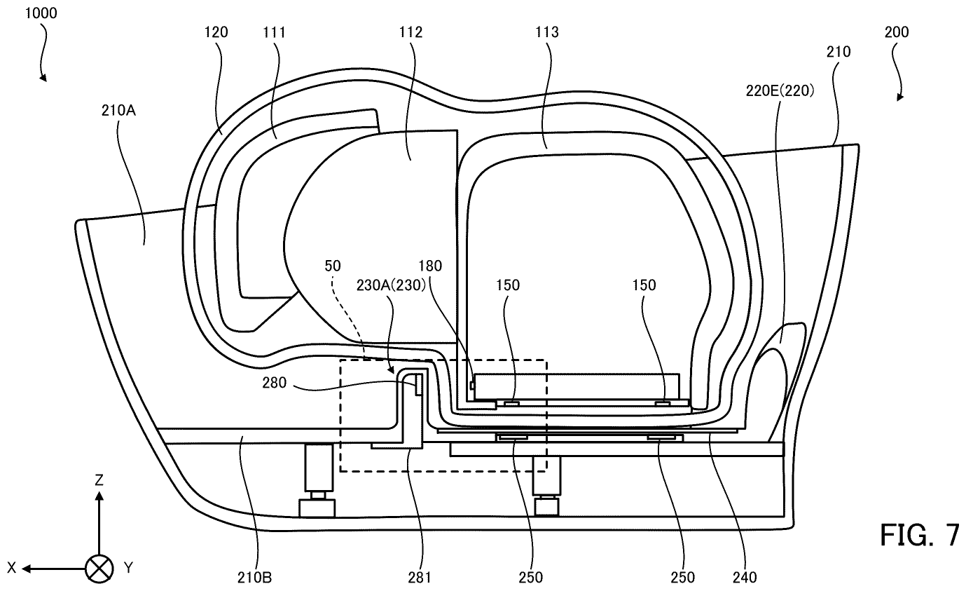

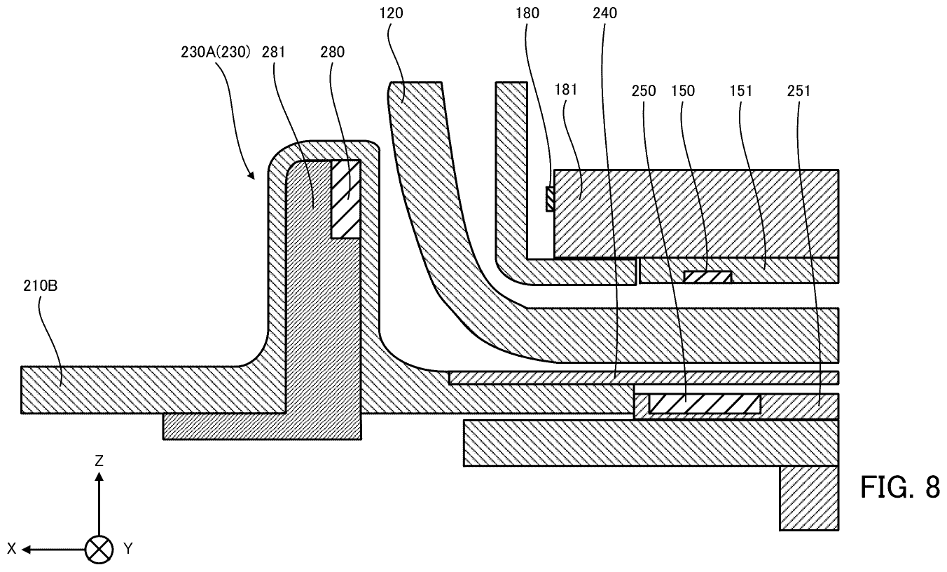

Next, the arrangement of the magnetic sensor 180 and the magnet 280 is described with reference to FIGS. 7 and 8. In FIG. 7, hatching for the cross-section is omitted for ease of understanding. As illustrated in FIGS. 7 and 8, in the accommodated state, the power reception coil 150 and the power transmission coil 250 face each other, and the magnetic sensor 180 and the magnet 280 face each other. That is, the power reception coil 150 and the power transmission coil 250 are close to each other and nearly overlap when viewed from the Z-axis direction. Also, the magnetic sensor 180 and the magnet 280 are close to each other and nearly overlap when viewed from the X-axis direction.

The power reception coil 150 is supported by a support member 151. The power reception circuit 160 may be built in the support member 151. The power transmission coil 250 is supported by a support member 251. The power transmission circuit 260 may be built in the support member 251. The magnetic sensor 180 is supported by a support member 181. The magnet 280 is supported by a support member 281.

The support member 281 is a member that supports the magnet 280. The support member 281 has a function of fixing the position and angle of the magnet 280 in the accommodated state so that the magnetic sensor 180 can detect magnetism generated by the magnet 280. In this embodiment, the support member 281 fixes the magnet 280 such that the longitudinal direction of the magnet 280 is the Y-axis direction, the width direction of the magnet 280 is the Z-axis direction, and the thickness direction of the magnet 280 is the X-axis direction.

In the accommodated state, the magnetic sensor 180 faces the magnet 280. The Y-coordinate of the magnetic sensor 180 and the Y-coordinate of the magnet 280 are approximately the same, and the Z-coordinate of the magnetic sensor 180 and the Z-coordinate of the magnet 280 are approximately the same. Additionally, the difference between the X-coordinate of the magnetic sensor 180 and the X-coordinate of the magnet 280 is equal to or less than a predetermined reference value. For example, this difference is preferably 20 millimeters or less.

When the electronic device 100 is disposed in the power supply device 200 (hereinafter referred to as an “suitable power supply device” as appropriate) that is a power supply device suitable for supplying power to the electronic device 100, the magnetism generated by the magnet 280 disposed at a predetermined part of the power supply device 200 is detected by the magnetic sensor 180 provided in the electronic device 100. In this case, the magnetic sensor 180 outputs a first voltage to the operation control terminal 162 of the power reception IC 161, and the power reception IC 161 is enable to operate. Consequently, the power supply request is transmitted from the power reception circuit 160 to the power transmission circuit 260, and power supply from the power supply device 200 to the electronic device 100 is achieved.

On the other hand, when the electronic device 100 is disposed in a power supply device (hereinafter referred to as “unsuitable power supply device” as appropriate) that is not suitable for supplying power to the electronic device 100, the magnetic sensor 180 provided in the electronic device 100 does not detect magnetism since the predetermined part in the unsuitable power supply device is not equipped with the magnet 280. In this case, the magnetic sensor 180 outputs a second voltage to the operation control terminal 162 of the power reception IC 161, and the operation of the power reception IC 161 is stopped. Consequently, the power supply request is not transmitted from the power reception circuit 160 to the power transmission circuit 260, and power supply from the power supply device 200 to the electronic device 100 is not realized.

In this way, in this embodiment, power supply from the unsuitable power supply device to the electronic device 100 is suppressed and various issues are reduced. For example, when the unsuitable power supply device does not have a foreign object detection function, heat generation caused by foreign objects is suppressed by suppressing power supply. For example, when the power transmission electrical energy of the unsuitable power supply device exceeds the receivable electrical energy of the electronic device 100, power supply exceeding the allowable amount of the electronic device 100 is suppressed by suppressing power supply. Also, for example, when the transmittable electrical energy of the unsuitable power supply device is extremely small, long-term power supply is suppressed by suppressing power supply.

In this embodiment, the side wall 210A provided in the housing 210 is provided with a plurality of wall-side protrusions 220 protruding inward from the side wall 210A. The wall-side protrusions 220 suppress movement of the electronic device 100 accommodated in the housing 210. Therefore, according to this embodiment, positional shift of the electronic device 100 receiving wireless power supply from the power supply device 200 can be suppressed.

If positional shift of the electronic device 100 occurs, various issues arise due to positional shift of the power transmission coil 250 and the power reception coil 150. Examples of the issues may include power supply stoppage, power supply stability reduction, increased power supply time, heat generation, and false detection of foreign objects. The power supply stoppage means, for example, the inability to supply power due to significant positional shift. The power supply stability reduction means, for example, frequent switching between power supply and power supply stoppage due to positional shift. The increased power supply time means, for example, a reduction in the power supply amount per unit time due to positional shift, increasing the time required for power supply.

The heat generation means, for example, excessive heat generation of the power transmission coil 250 due to increased power during power supply to compensate for reduced power supply amount caused by positional shift. The false detection of foreign objects means, for example, false detection of foreign objects caused by heat generation as described above. For example, in a case of determining that there is a foreign object is made when a rise rate of the temperature detected by the temperature sensor 272 is equal to or greater than a threshold, even if there is not a foreign object, determination that there is a foreign object might be made when the power transmission coil 250 excessively generates heat due to positional shift. In this embodiment, these issues caused by positional shift of the electronic device 100 are reduced.

As methods to suppress positional shift of the electronic device 100, for example, methods such as narrowing the width of the power supply device 200 or reducing the size of the power supply device 200 are conceivable. However, as for the method of narrowing the width of the power supply device 200, the aspect ratio of the power supply device 200 changes, which may impair the design aesthetics of the power supply device 200. Furthermore, as for the method of reducing the size of the power supply device 200, the balance between the size of the electronic device 100 and the size of the power supply device 200 changes, which may impair the overall design aesthetics of the electronic device 100 and the power supply device 200. Additionally, the method of narrowing the width of the power supply device 200 or reducing the size of the power supply device 200 may not secure enough space to insert fingers between the exterior 120 of the electronic device 100 and the side wall 210A of the housing 210 of the power supply device 200, making it difficult for users to accommodate the electronic device 100 in the housing 210.

In this embodiment, the floor-side protrusions 230 restrict the movement of the electronic device 100 in the first direction, and the wall-side protrusions 220 restrict the movement of the electronic device 100 in the second direction orthogonal to the first direction. According to this embodiment, the wall-side protrusions 220 and the floor-side protrusions 230 appropriately suppress the movement of the electronic device 100 in the first and second directions.

In this embodiment, the power transmission circuit 260 supplies power to the electronic device 100 in response to a power supply request issued when the electronic device 100 detects the magnetism generated by the magnet 280 disposed inside the floor-side protrusion 230A. Therefore, in this embodiment, the floor-side protrusion 230A has a function of restricting the movement of the electronic device 100 and a function of fixing the magnet 280 used to suppress inappropriate power supply. According to this embodiment, inappropriate power supply can be suppressed while suppressing positional shift of the electronic device 100 with a simple configuration.

In this embodiment, the first, second, third, and fourth protrusions are arranged such that the positions in the first direction of the first, second, third, and fourth protrusions are between the positions at both ends in the first direction of the wide portion 113A of the electronic device 100 when the electronic device 100 is accommodated in the housing 210. Thus, according to this embodiment, the movement of the electronic device 100 in the second direction orthogonal to the first direction is efficiently suppressed by the first, second, third, and fourth protrusions.

In this embodiment, the interval between the first and second protrusions and the interval between the third and fourth protrusions correspond to the thickness of a finger. In this embodiment, for example, when a user accommodates the electronic device 100 in the housing 210 while holding both ends of the wide portion 113A in a direction orthogonal to the width direction with the fingers, one finger of the user is considered to enter between the first and second protrusions, and another finger of the user is considered to enter between the third and fourth protrusions. Thus, according to this embodiment, users is considered to easily accommodate the electronic device 100 in the housing 210.

However, in a case where the intervals mentioned above are too short compared to the thickness of fingers, sufficient space for inserting user's fingers cannot be secured, making it difficult for the user to accommodate the electronic device 100 in the housing 210. In a case where the intervals mentioned above are too long compared to the thickness of fingers, the movement of the electronic device 100 might not be sufficiently suppressed. Additionally, instead of providing the wall-side protrusions 220 on the side wall 210A, for example, a method of providing a continuous protrusion around the entire inner side of the side wall 210A can be considered. However, with this method, a user's finger may get caught between the exterior 120 of the electronic device 100 and the continuous protrusion, making it difficult for the user to accommodate the electronic device 100 in the housing 210.

In this embodiment, the wall-side protrusions 220 have a rounded shape. Thus, in this embodiment, a user's finger, the exterior 120 of the electronic device 100, or the like is considered to be less likely to get caught on the wall-side protrusions 220 when the electronic device 100 is accommodated in the housing 210. Thus, according to this embodiment, users is considered to easily accommodate the electronic device 100 in the housing 210.

In this embodiment, the housing 210 accommodates a pet-like robot having the head 111 and the torso 113, and the side wall 210A has wall-side protrusions 220 arranged to protrude inward from the side wall 210A and cover the torso 113, thereby restricting movement of the torso 113 while not restricting the movement of the head 111. According to this embodiment, biological movements involving movement of the head 111 are not restricted by the wall-side protrusions 220, maintaining the animal-like movements of the pet-like robot. Such biological movements include, for example, breathing movement realized by the movement of the head 111.

In this embodiment, the floor-side protrusion 230 is configured to support a portion between the head 111 and the torso 113 of the robot, so as not to restrict the movement of the head 111. According to this embodiment, the biological movements involving the head 111 are not restricted by the floor-side protrusion 230, maintaining the animal-like movements of the pet-like robot.

### Embodiment 2

In Embodiment 1, an example is described in which the housing 210 is provided with the wall-side protrusions 220 and the floor-side protrusion 230. In this embodiment, an example is described in which the housing 210 is provided with the wall-side protrusions 220 but not with the floor-side protrusion 230. Similar configurations and functions to those of Embodiment 1 are appropriately omitted or simplified.

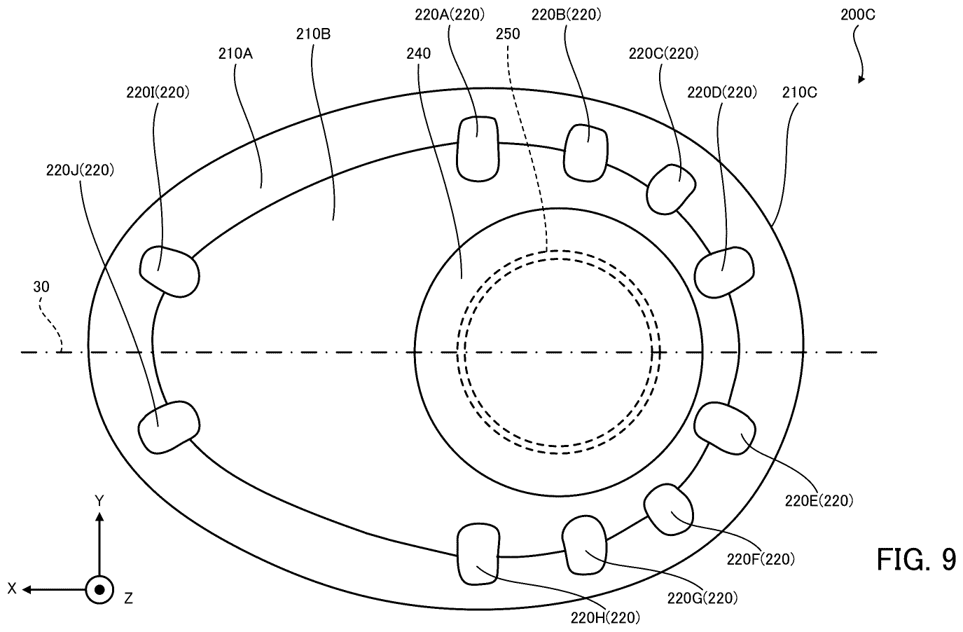

FIG. 9 is a top view illustrating the power supply device 200C according to this embodiment. The power supply device 200C basically has the same configuration as the power supply device 200, except that the power supply device 200 includes a housing 210C instead of the housing 210. The housing 210C has the same configuration as the housing 210, except that housing 210C includes the wall-side protrusions 2201 and 220J instead of the floor-side protrusions 230A and 230B.

In this embodiment, the wall-side protrusions 220 include a wall-side protrusion 220 that restricts the movement of the electronic device 100 in the first direction, and a wall-side protrusion 220 that restricts the movement of the electronic device 100 in the second direction orthogonal to the first direction. Specifically, movement in the direction corresponding to the first orientation in the first direction of the electronic device 100 is suppressed by the wall-side protrusions 2201 and 220J.

Additionally, movement in the direction corresponding to the second orientation in the first direction of the electronic device 100 is suppressed by the wall-side protrusions 220C, 220D, 220E, and 220F. Movement in the direction corresponding to the first orientation in the second direction of the electronic device 100 is suppressed by the wall-side protrusions 220A, 220B, and 220C. Movement in the direction corresponding to the second orientation in the second direction of the electronic device 100 is suppressed by the wall-side protrusions 220F, 220G, and 220H.

In this embodiment, the wall-side protrusions 220 include a wall-side protrusion 220 that restricts the movement of the electronic device 100 in the first direction, and a wall-side protrusion 220 that restricts the movement of the electronic device 100 in the second direction orthogonal to the first direction. In this embodiment, the movement of the electronic device 100 in the first direction and the second direction is suppressed without providing floor-side protrusions 230 on the floor 210B. That is, in this embodiment, the movement of the electronic device 100 in the first direction and the second direction is suppressed with a simple configuration.

### Modified Examples

Although the embodiments are described above, the embodiments may be modified or applied in various manners. Any part of the configurations, functions, and operations described in the above embodiments may be employed. Further, besides the configurations, functions, and operations described above, additional configurations, functions, and operations may be employed. Further, the configurations, functions, and operations described in the above embodiments can be freely combined.

In Embodiment 1, an example is described in which the power supply device 200 includes eight wall-side protrusions 220 and two floor-side protrusions 230. The number of the wall-side protrusions 220 or the floor-side protrusions 230 included in the power supply device 200 is not limited to this example. For example, the power supply device 200 may include seven or fewer or nine or more wall-side protrusions 220, and one or fewer or three or more floor-side protrusions 230.

In Embodiment 1, an example is described in which the wall-side protrusions 220 are provided at the boundary portion between the side wall 210A and the floor 210B. The wall-side protrusions 220 do not need to be provided at the boundary portion between the side wall 210A and the floor 210B, and may be provided above the boundary portion on the side wall 210A.

In Embodiment 1, an example is described in which the electronic device 100 is a robot imitating a small animal. The electronic device 100 may be other robots or non-robot devices. For example, the electronic device 100 may be a smartphone, an electronic dictionary, a game device, or the like.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. A power supply device, comprising:
a housing to accommodate an electronic device to supply power in a non-contact manner to the electronic device,
the housing comprising
a floor on which the electronic device is placed, and
a wall to surround the electronic device, wherein
the wall is provided with a plurality of wall-side protrusions protruding inward from the wall.

2. The power supply device according to claim 1, wherein
the floor is provided with a floor-side protrusion protruding upward from the floor,
the floor-side protrusion restricts movement of the electronic device in a first direction, and
the plurality of wall-side protrusions include a wall-side protrusion that restricts movement of the electronic device in a second direction substantially orthogonal to the first direction.

3. The power supply device according to claim 2, wherein
a magnet is installed inside the floor-side protrusion, and
the power supply device comprises a power transmission circuit to supply power to the electronic device in response to a power supply request issued when the electronic device detects a magnetic field generated by the magnet.

4. The power supply device according to claim 1, wherein the plurality of wall-side protrusions include a wall-side protrusion that restricts movement of the electronic device in the first direction and a wall-side protrusion that restricts movement of the electronic device in the second direction orthogonal to the first direction.

5. The power supply device according to claim 1, wherein
the electronic device has a wide portion that has a length in a width direction of the electronic device longer than other portions,
the plurality of wall-side protrusions include a first protrusion, a second protrusion adjacent to the first protrusion, a third protrusion arranged in line symmetry with the first protrusion with respect to an axis extending in the first direction as a symmetry axis, and a fourth protrusion adjacent to the third protrusion and arranged in line symmetry with the second protrusion with respect to the axis as the symmetry axis,
the housing accommodates the electronic device such that the width direction of the electronic device is orthogonal to the first direction, and
when the electronic device is accommodated in the housing, positions of the first protrusion, the second protrusion, the third protrusion, and the fourth protrusion in the first direction are arranged to be positioned between the positions of both ends of the wide portion in the first direction.

6. The power supply device according to claim 5, wherein an interval between the first protrusion and the second protrusion and an interval between the third protrusion and the fourth protrusion are sized in accordance with a thickness of a finger.

7. The power supply device according to claim 1, wherein the plurality of wall-side protrusions has a rounded shape.

8. A power supply device, comprising:
a housing to accommodate a pet-type robot having a head and a torso,
the housing comprising
a floor on which the robot is placed, and
a wall to surround the robot, wherein
the wall includes a protrusion protruding inward from the wall and arranged to cover the torso such that movement of the torso is suppressed and movement of the head is allowed.

9. The power supply device according to claim 8, wherein
the floor is provided with a floor-side protrusion protruding upward from the floor, and
the floor-side protrusion is configured to support a portion of the robot between the head and the torso such that the movement of the head is allowed.

10. A power transmission system, comprising:
a power supply device; and
an electronic device,
the power supply device comprising
a power transmission coil,
a power transmission circuit to supply power wirelessly to the electronic device through the power transmission coil, and
a housing to accommodate the electronic device at a time of power supply, the electronic device comprising
a battery,
a power reception coil, and
a power reception circuit to supply, to the battery, power wirelessly received from the power supply device through the power reception coil,
the housing comprising
a floor on which the electronic device is placed, and
a wall to surround the electronic device, wherein
the wall is provided with a plurality of wall-side protrusions protruding inward from the wall, and
the electronic device, when accommodated in the housing, is restricted to move by the plurality of wall-side protrusions.
